(19) United States
(12) Patent Application Publication
(10) Pub. No.: US 2013/0106182 A1
(43) Pub. Date: May 2, 2013

(54) APPARATUS FOR SUPPLYING MULTI-OUTPUT AND DISPLAY APPARATUS USING THE SAME

(71) Applicants: Sung-yong JOO, Yongin-si (KR); Sung-bum JUNG, Yongin-si (KR)

(72) Inventors: Sung-yong JOO, Yongin-si (KR); Sung-bum JUNG, Yongin-si (KR)

(73) Assignee: SAMSUNG ELECTRONICS CO., LTD., Suwon-si (KR)

(21) Appl. No.: 13/618,441

(22) Filed: Sep. 14, 2012

(30) Foreign Application Priority Data
Oct. 27, 2011 (KR) 10-2011-0110625

(51) Int. Cl. H02J 1/00

(52) U.S. Cl. 307/24

(57) ABSTRACT

A multi output power supply is provided. The power supply includes an input power unit which generates an LLC resonance signal using DC power, a primary output power unit which outputs a first output voltage based on a first voltage induced in response to the LLC resonance signal, a secondary output power unit which outputs a second output voltage based on a second voltage induced in response to the LLC resonance signal, and a power control unit which controls the input power unit to change the LLC resonance signal so that the first output voltage has a preset level, and controls the secondary output power unit so that the second output voltage has a preset level irrespective of a change in a level of the first output voltage.

### CROSS-REFERENCE TO RELATED APPLICATIONS

This application claims priority from Korean Patent Application No. 10-2011-0110625, filed on Oct. 27, 2011 in the Korean Intellectual Property Office, the disclosure of which is herein incorporated by reference in its entirety.

### BACKGROUND

1. Field

Apparatuses consistent with exemplary embodiments relate to multi power output, and more particularly, to an apparatus which converts a single input power at a primary side into a plurality of outputs at a secondary side, and a display apparatus using the same.

2. Description of the Related Art

A multi power output supply operates to convert a single input power at a primary side into a plurality of output powers at a secondary side and supply the converted power.

Many efforts have been made to develop smaller and lighter multi power output supplies to suit the increasing degree of integration of planar displays such as plasma display panels (PDP), liquid crystal displays (LCD), or the like.

However, since the multi output power supply has to vary all the output voltages, the multi output power supply has a rather complicated circuit configuration and needs many components, which is the main obstacle to develop the multi output power supply in a smaller and lighter form.

One type of related art multi output power supply controls the output of an early stage using a feedback method such that such that all output voltages change together. Accordingly, to obtain output voltages that vary independently an additional separate circuit such as a linear regulator is needed.

The ‘linear regulator’ can vary voltages, and is generally implemented as the voltage drop circuit to output a lower power compared to an input power.

However, in using a linear regulator, when the output of the early stage increases, the head room voltage at the front end of the linear regulator also increases, resulting in temperature rise of the linear regulator and subsequent degradation of efficiency.

Further, related art multi output power supplies also exhibit deteriorated productivity as the multi output power supply needs separate variable resistances to vary the output voltages according to the output voltage levels as desired by the manufacturer.

### SUMMARY

Exemplary embodiments of the present invention overcome the above disadvantages and other disadvantages not described above. Also, the present invention is not required to overcome the disadvantages described above, and an exemplary embodiment of the present invention may not overcome any of the problems described above.

One or more exemplary embodiments provide a multi output power supply apparatus which is capable of automatically adjusting output voltages, and a display apparatus using the same are provided.

One or more exemplary embodiments also provide a multi output power supply apparatus which has increased thermal characteristic and efficiency because head room voltages are variable therein, and a display apparatus using the same.

According to an aspect of an exemplary embodiment, there is provided a multi output power supply apparatus including an input power unit which generates an LLC resonance signal using DC power, a primary output power unit which outputs a first output voltage based on a first voltage induced in response to the LLC resonance signal, a secondary output power unit which outputs a second output voltage based on a second voltage induced in response to the LLC resonance signal, and a power control unit which controls the input power unit to change the LLC resonance signal so that the first output voltage has a preset level, and controls the secondary output power unit so that the second output voltage has a preset level irrespective of a change in a level of the first output voltage.

The input power unit may comprise a plurality of switching devices, a first winding, a first inductor, a second inductor and a first capacitor, and the LLC resonance signal may be generated by the switching devices, the first winding, the first inductor, the second inductor, and the first capacitor.

The input power unit may include a first switching device and a second switching device connected in series with the first switching device, a first inductor connected commonly to the first switching device and the second switching device, a first capacitor connected to the second switching device, a second inductor connected to the first capacitor and the first inductor, a first winding connected in parallel to the second inductor, and a feedback control unit which controls a switching operation of the first switching device and the second switching device so that the LLC resonance signal is generated at a preset level.

The primary output power unit may include a second winding which generates an induced current in response to the LLC resonance signal, a plurality of diodes which rectify a voltage output from the second winding, a second capacitor which levels the rectified voltage to generate the first output voltage, and a feedback signal generating unit which generates a feedback signal to cause the first output voltage to have the preset level.

The power control unit may control the feedback signal generating unit according to a level of the first output voltage, so that the feedback signal is generated, to cause the first output voltage to have the preset level.

The feedback signal generating unit may include a third switching device, and the power control unit may output a PWM duty signal to the third switching device to cause the first output voltage to have the preset level.

The secondary output power unit may include a third winding and a fourth winding connected in series with the third winding, each of which generates an induced current in response to the LLC resonance signal, a fourth switching device which switches to cause the fourth winding to operate selectively, a fifth diode which rectifies a voltage output from the third winding and the fourth winding, or a voltage output only from the third winding, according to a switching operation of the four switching device, a third capacitor which levels the rectified voltage, and a regulator which converts the leveled voltage to generate the second output voltage having the preset level. The power control unit may control the switching operation of the fourth switching device so that the second output voltage has the preset level irrespective of a change in the level of the first output voltage.

The power control unit may control the fourth switching device to switch on, if the level of the first output voltage is greater than a preset level.

The secondary output power unit may include a fifth winding which generates an induced current in response to the LLC resonance signal, a sixth diode which rectifies a voltage output from the fifth winding, a fourth capacitor which levels a voltage output from the sixth diode, a regulator which converts a voltage output from the fourth capacitor to a preset level, and a fifth switching device which controls a switching operation of the regulator. The power control unit may control a switching operation of the fifth switching device so that the second output voltage has the preset level irrespective of a change in the level of the first output voltage.

The power control unit may output a PWM duty signal to the fifth switching device to cause the second output voltage to have the preset level.

According to an aspect of another exemplary embodiment, there is provided a display apparatus including a display unit which displays an image, a control unit which controls the display unit, and a multi output power supply unit which supplies power to the display unit and the control unit, in which the multi output power supply unit may include an input power unit which generates an LLC resonance signal using DC power, a primary output power unit which outputs a first output voltage based on a first voltage induced in response to the LLC resonance signal, a secondary output power unit which outputs a second output voltage based on a second voltage induced in response to the LLC resonance signal, and a power control unit which controls the input power unit to change the LLC resonance signal so that the first output voltage has a preset level, and controls the secondary output power unit so that the second output voltage has a preset level irrespective of a change in a level of the first output voltage.

The primary output power unit may include a second winding which generates an induced current in response to the LLC resonance signal, a plurality of diodes which rectify a voltage output from the second winding, a second capacitor which levels the rectified voltage to generate the first output voltage, and a feedback signal generating unit which generates a feedback signal to cause the first output voltage to have the preset level.

The feedback signal generating unit may include a third switching device, and the power control unit may output a PWM duty signal to the third switching device to cause the first output voltage to have the preset level.

The secondary output power unit may include a third winding and a fourth winding connected in series with the third winding, each of which generates an induced current in response to the LLC resonance signal, a fourth switching device which switches to cause the fourth winding to operate selectively, a fifth diode which rectifies a voltage output from the third winding and the fourth winding, or a voltage output only from the third winding, according to a switching operation of the fourth switching device, a third capacitor which levels the rectified voltage, and a regulator which converts the leveled voltage to output the second output voltage having the preset level. The power control unit controls the switching operation of the fourth switching device so that the second output voltage has a preset level irrespective of a change in the level of the first output voltage.

If the level of the first output voltage is greater than a preset level, the power control unit may control the fourth switching device to switch on.

The secondary output power unit may include a fifth winding which generates an induced current in response to the LLC resonance signal, a sixth diode which rectifies a voltage output from the fifth winding, a fourth capacitor which levels a voltage output from the sixth diode, a regulator which converts a voltage output from the fourth capacitor to output the second output voltage having the preset level, and a fifth switching device which controls a switching operation of the regulator. The power control unit may control a switching operation of the fifth switching device so that the second output voltage has the preset level irrespective of the change in the level of the first output voltage.

The power control unit may output a PWM duty signal to the fifth switching device to cause the second output voltage to have the preset level.

### BRIEF DESCRIPTION OF THE DRAWINGS

The above and/or other aspects will be more apparent by describing certain exemplary embodiments with reference to the accompanying drawings, in which:

FIG. 1 is a block diagram of a multi output power supply apparatus according to an exemplary embodiment;

FIG. 2 is a block diagram illustrating the multi output power supply apparatus of FIG. 1 in detail;

FIG. 3 is a circuit diagram illustrating a multi-output power supply apparatus according to an exemplary embodiment;

FIG. 4 is a circuit diagram illustrating a multi output power supply apparatus according to another exemplary embodiment;

FIGS. 5 and 6 are views provided to explain a method for controlling a multi output power supply apparatus according to an exemplary embodiment; and

FIG. 7 is a block diagram of a display apparatus according to another exemplary embodiment.

### DETAILED DESCRIPTION OF EXEMPLARY EMBODIMENTS

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the inventive concept. Thus, it is apparent that the exemplary embodiments can be carried out without those specifically defined matters. Also, well-known functions or constructions are not described in detail since they would obscure the inventive concept with unnecessary detail.

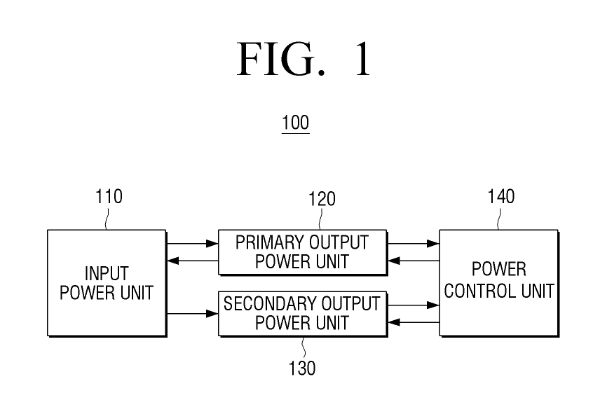

FIG. 1 is a block diagram of a multi output power supply apparatus according to an exemplary embodiment. Referring to FIG. 1, the multi output power supply apparatus 100 may include an input power unit 110, a primary output power unit 120, a secondary output power unit 130, and a power control unit 140.

The input power unit 110 generates power to be applied to the first and secondary output power units 120, 130. To be more specific, the input power unit 110 may receive direct current (DC) power and generate a inductor-inductor-capacitor (LLC) resonance signal to be applied to the first and secondary output power units 120, 130.

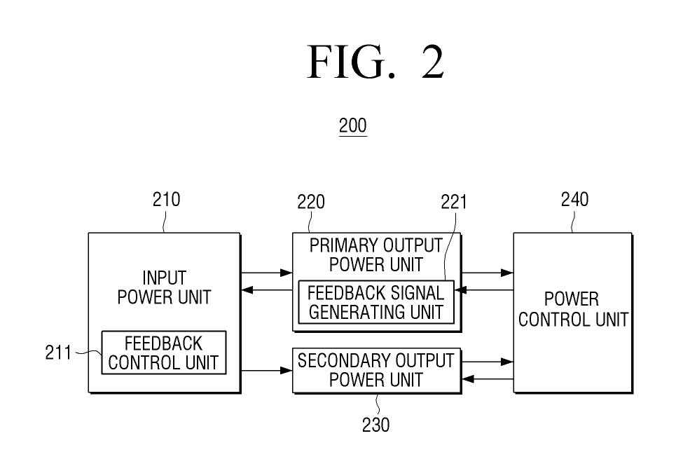

As used herein, the input power unit 110 may include a first switching device and a second switching device connected in series with the first switching device, a first inductor connected commonly to the first switching device and the second switching device, a first capacitor connected to the second switching device, a second inductor connected to the first inductor, a first winding connected in parallel with the second inductor, and feedback control unit which controls switching operation of the first switching device and the second switching device to generate the LLC resonance signal at a predetermined level. The detailed operation of the feedback control unit will be explained below with reference to FIG. 2.

The input power unit 110 may include the first capacitor only, which is connected in series with the first winding. That is, the input power unit 110 may be provided without the first inductor and the second inductors.

The input power unit 110 may operate in the manner explained below.

In accordance with the switching operation of the first switching device and the second switching device in response to mutually-complementary switching signals, and the resonance at the first capacitor, the first inductor, the second inductor and the LLC resonance, an LLC resonance signal may be generated.

As used herein, the first switching device and the second switching device may be implemented as a metal on semiconductor field effect transistor (MOSFET) to carry out the switching.

The primary output power unit 120 outputs a first output voltage. To be more specific, the induced voltage may be output as a first output voltage based on the LC resonance signal generated at the input power unit 110.

As used herein, the primary output power unit 120 may include a second winding, a plurality of diodes connected to the second winding, a second capacitor connected to the plurality of diodes, and a feedback signal generating unit connected to the second capacitor.

The primary output power unit 120 may operate in the manner explained below.

The second winding may generate an induced current in response to the LLC resonance signal.

The plurality of diodes may rectify the voltage output from the second winding. The second capacitor may output the voltage output from the second winding. The second capacitor may level the rectified voltage and output the leveled voltage as a first voltage. The feedback signal generating unit may generate a feedback signal so that the first output voltage has a preset level. The detailed operation of the feedback signal generating unit will be explained below with reference to FIG. 2.

As explained above, the first output power unit 120 may be implemented as a full-wave rectifier. However, the first output power unit 120 is not limited to this, and according to other exemplary embodiments, it is possible to implement the first output power unit 120 as a half-wave rectifier circuit using one diode.

The secondary output power unit 130 may output a second output voltage. To be more specific, the secondary output power unit 130 may output a second output voltage with the voltage which is induced in response to the generated LLC resonance signal.

As used herein, the secondary output power unit 130 may include a third winding and a fourth winding connected in series with the third winding, a fourth switching device, in which a drain is connected to a common node of the third winding and the fourth winding, a source is connected to ground, and a gate is connected to the power control unit 140, a third and fifth capacitors connected in parallel to the third winding and the fourth winding, a third diode connected between the third winding and the third capacitor, and a regulator connected between the third capacitor and the fifth capacitor.

The secondary output power unit 130 may operate in the manner explained below.

The third winding and the fourth winding in series connection with each other may generate an induced current in response to the LLC resonance signal generated at the input power unit 110. The fourth switching device may switch to cause the fourth winding to operate selectively. Further, the fifth diode may rectify the voltage output from the fourth winding and the fifth winding, or voltage output from the fourth winding. The third capacitor may level the rectified voltage. The regulator may convert the leveled voltage into a preset level. The fifth capacitor may level the output voltage from the regulator and output the leveled voltage as the second output voltage.

The secondary output power unit 130 may include a fifth diode, a sixth diode connected to the fifth diode, a fourth capacitor and a fifth capacitor connected in parallel to the fifth winding, a regulator, and a fifth switching device connected to the regulator.

The secondary output power unit 130 may operate in the manner explained below.

The fifth winding may generate a current induced in response to the LLC resonance signal generated at the input power unit 110. The sixth diode may rectify the voltage output from the fifth winding. The fourth capacitor may level the voltage output from the sixth diode. The regulator may convert the voltage output from the fourth capacitor to a preset level. The fifth switching device may control the operation of the regulator. The fifth capacitor may level the output voltage from the regulator and output the leveled voltage as the second output voltage.

The third, fourth and fifth switching devices may be implemented as a MOSFET to carry out the switching. As explained above, the secondary output power unit 130 may be implemented as a half-wave rectifier, but is not limited to this. In other exemplary embodiments, it is possible to implement the secondary output power unit 130 as a full-wave rectifier circuit using a plurality of diodes.

The power control unit 140 may control so that the first output voltage of the primary output power unit 120 has a preset level, the second output voltage of the secondary output power unit 130 has a preset level, and the head room voltage of the secondary output power unit 130 has a preset level.

To be more specific, the power control unit 140 may control the input power unit 110 to change the LLC resonance signal so that the first output voltage has a preset level. That is, the power control unit 140 may detect the level of the first output voltage and control the feedback signal generating unit to generate a feedback signal which causes the first output voltage to have a preset level. Accordingly, the feedback signal generating unit transfers the generated feedback signal to the feedback control unit, and the feedback control unit may control the switching of the switching device of the power input unit 110 so that the primary output power unit 120 outputs a preset level of voltage. That is, to increase the level of the first output voltage, duty of the PWM signal applied at the gate end of the third switching device is increased, while to decrease the level of the first output voltage, duty of the PWM signal applied at the gate end of the third switching device may be decreased.

Further, the power control unit 140 may control the switching of the fifth switching device so that the second output voltage has a preset level irrespective of the change in the level of the first output voltage. That is, the power control unit 140 may provide the fifth switching device with a PWM duty signal to cause the second output voltage to have a preset level. Accordingly, to increase the level of the second output voltage, the duty of the PWM signal applied at the gate end of the fifth switching device may be increased, while to decrease the level of the second output voltage, duty of the PWM signal applied at the gate end of the fifth switching device may be decreased.

Further, the power control unit 140 may control the switching of the fourth switching device so that the second output voltage has a preset level irrespective of the change in the level of the first output voltage.

The multi output power supply apparatus 100 according to an exemplary embodiment uses the feedback method to control the output voltage of the primary output power unit 120 by controlling the output of the input power unit 110. However, if output of the input power unit 110 changes, the output of the secondary output power unit 130 changes too. Accordingly, an additional circuit such as a linear regulator is included in the secondary output power unit 120 to obtain the voltage that can vary independently of the primary output power unit 120. However, even when the regulator is provided, since the head room voltage at the front end of the regulator of the secondary output power unit 130 increases in accordance with the increase in the output of the input power unit 110, disadvantages such as temperature rise and deteriorated efficiency of the switching device of the linear regulator can happen. The exemplary embodiment overcomes the above-mentioned disadvantages, since according to the multi output power supply apparatus 100 according to the exemplary embodiment, it is possible to control the head room voltage by controlling the fourth switching device. That is, if the level of the first output voltage is greater than a preset level (i.e., if the level of the first output voltage increases, resulting in an increase in the head room voltage applied to the regulator), it is possible to control so that the fourth switching device alone is switched on. If the fourth switching device is switched on, only the third winding operates, and as a result, the number of windings is reduced from when both the third and fourth windings operate, and the head room voltage is decreased.

In an exemplary embodiment, the multi output power supply apparatus is enabled to adjust the output voltage automatically, to thus provide improved productivity.

In various exemplary embodiments, the multi output power supply apparatus can also adjust the head room voltage to thus provide maximized output efficiency.

FIG. 2 is a detailed block diagram of the multi output power supply apparatus of FIG. 1. Referring to FIG. 2, the multi output power supply apparatus 200 may include an input power unit 210, a feedback control unit 211, a primary output power unit 220, a feedback signal generating unit 221, a secondary output power unit 230, and a power control unit 240. Some elements overlapping those illustrated in FIG. 1 and explained above will not be explained in detail for the sake of brevity.

The feedback control unit 211 controls the output of the input power unit 210.

To be more specific, the feedback control unit 211 may control the first switching device and the second switching device of the input power unit 210 based on a feedback signal generated at the feedback signal generating unit 221.

As used herein, the feedback control unit 211 may perform PWM control. That is, to control the first switching device and the second switching device in accordance with the PWM control method, the feedback control unit 211 may control the output of the input power unit 210 by adjusting the duty of the pulse applied at the gate of the first switching device and the second switching device. Further, to control the first and second switching devices in accordance with the PFM control method, the feedback control unit 211 may control the output of the input power unit 210 by adjusting the frequency of the pulse applied to the gate of the first switching device and the second switching device.

The feedback signal generating unit 221 generates a feedback signal applied at the feedback control unit 211. To be more specific, the feedback signal generating unit 221 may generate a feedback signal so that the output voltage of the primary output power unit 220 has a preset level.

That is, the feedback signal generating unit 221 may operate in a manner explained below. The feedback signal generating unit 221 may detect the output voltage of the primary output power unit 220 using a plurality of resistances. Further, the feedback signal generating unit 221 may generate a feedback signal based on an external power signal. Further, the feedback signal generating unit 221 may include a shunt regulator which compares the detected output voltage of the primary output power unit 220 with a reference voltage (Vref) of, for example, about 2.5 V. The feedback signal generating unit 221 may then output a feedback signal based on the result of comparison to the feedback control unit 211 via a photo coupler. Accordingly, if the output voltage of the primary output power unit 220 is set to 200 V, a feedback signal may be generated so that the output voltage becomes 200V.

Further, the feedback signal generating unit 221 may generate a feedback signal so that the first output voltage has a preset level. That is, the power control unit 140 may provide a PWM duty signal to the third switching device so that the first output voltage has a preset level, and the feedback signal generating unit 221 may generate a feedback signal based on the PWM duty signal applied at the third switching device so that the first output voltage has a preset level, and transfers the generated feedback signal to the feedback control unit 211. That is, to increase the level of the first output voltage, a duty of the PWM signal applied at the gate end of the third switching device is increased, while to decrease the level of the first output voltage, a duty of the PWM signal applied at the gate end of the third switching device may be decreased. Accordingly, as an example, for the first output power unit 220 currently having a first output voltage of 202 V, by decreasing the duty of the PWM signal applied at the gate end of the third switching device, it is possible to automatically adjust the first output voltage to 200V.

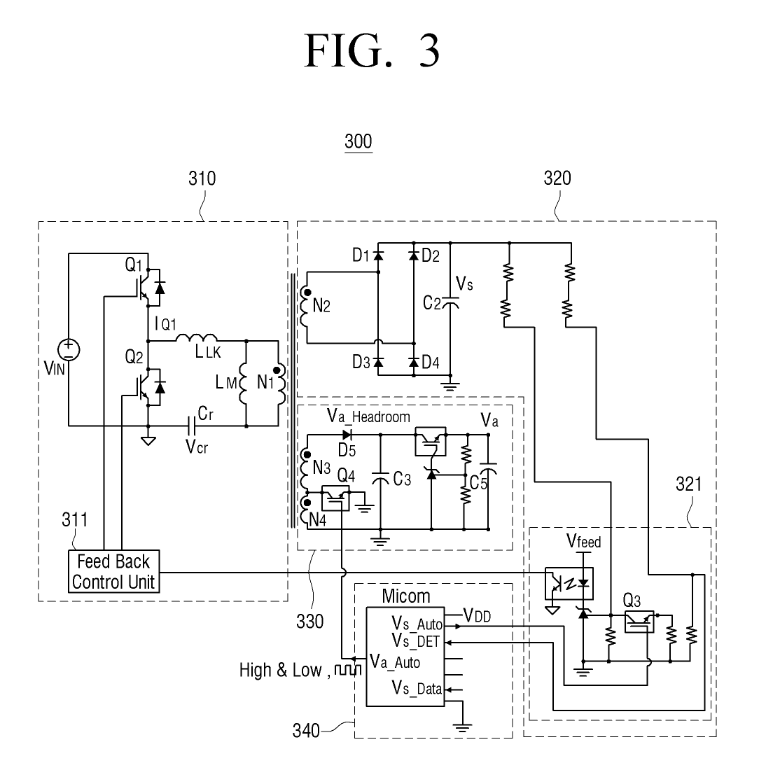

FIG. 3 is a circuit diagram of a multi output power supply apparatus according to an exemplary embodiment. Referring to FIG. 3, the multi output power supply apparatus 300 may include an input power unit 310, a feedback control unit 311, a primary output power unit 320, a feedback signal generating unit 321, a secondary output power unit 330, and a power control unit 340.

The input power unit 310 may include a first switching device Q1 and a second switching device Q2 connected in series with the first switching device Q1, a first inductor LLK connected commonly to the first switching device Q1 and the second switching device Q2, a first capacitor Cr connected to the second switching device Q2, a second inductor LM connected to the first capacitor Cr and the first inductor LLK, a first winding N1 connected in parallel with the second inductor LM, and a feedback control unit 311 which controls the switching of the first switching device Q1 and the second switching device Q2 so that a preset level of an LLC resonance signal is generated at the first winding N1.

The input power unit 310 may operate in the manner explained below.

In accordance with the switching operation at the first switching device Q1 and the second switching device Q2 in response to mutually-complementary switching signals, and the resonance at the first capacitor Cr, the first inductor LLK, the second inductor LM and the LLC resonance, an LLC resonance signal may be generated.

The primary output power unit 320 may include a second winding N2, a plurality of diodes D1, D2, D3, D4 connected to the second winding N2, a second capacitor C2 connected to the plurality of diodes D1 to D4, and a feedback signal generating unit 321 connected to the second capacitor C2.

The primary output power unit 320 may operate in the manner explained below.

The second winding N2 may generate an induced current in response to the LLC resonance signal generated by the input power unit 310. The plurality of diodes D1, D2, D3, D4 may rectify the voltage output from the second winding N2. The second capacitor C2 may level the rectified voltage. The feedback signal generating unit 321 may generate a feedback signal so that the first output voltage has a preset level.

As used herein, the secondary output power unit 330 may include a third winding N3 and a fourth winding N4 connected in series with the third winding N3, a fourth switching device Q4, in which a drain is connected to a common node of the third winding N3 and the fourth winding N4, a source is connected to ground, and a gate is connected to the power control unit 340, a third capacitor C3 and a fifth capacitor C5 connected in parallel to the third winding N3 and the fourth winding N4, a fifth diode D5 connected between the third winding N3 and the third capacitor C3, and a regulator connected between the third capacitor C3 and the fifth capacitor C5.

The secondary output power unit 330 may operate in the manner explained below.

The third winding N3 and the fourth winding N4 in series connection with each other may generate an induced current in response to the LLC resonance signal generated by the first winding N2 of the input power unit 310. The fourth switching device Q4 may switch to cause the fourth winding N4 to operate selectively. Further, the fifth diode D5 may rectify the voltage output from the third winding N3 and the fourth winding N4, or voltage output from only the third winding N3. The third capacitor C3 may level the rectified voltage. The regulator may convert the leveled voltage into a preset level Va.

The power control unit 340 may include a microcomputer Micom, and may operate in the manner explained below.

To be more specific, the power control unit 340 may control the input power unit 310 so that the LLC resonance signal generated by the first winding N1 of the input power unit 310 is varied to cause the first output voltage to have a preset level. That is, the power control unit 340 may detect the first output voltage and control the feedback signal generating unit 321 to generate a feedback signal to cause the first output voltage to have a preset level. Accordingly, the feedback signal generating unit 321 transfers the generated feedback signal to the feedback control unit 311 and the feedback control unit 311 may control the switching operation of the first switching device Q1 and the second switching device Q2 of the input power unit 310 so that the primary output power unit 320 outputs a predetermined level of voltage. That is, to increase the level of the first output voltage, a duty of a PWM signal applied at the gate end of the third switching device Q3 of the feedback signal generating unit 321 is increased, while to decrease the level of the first output voltage, a duty of the PWM signal applied at the gate end of the third switching device Q3 may be decreased.

Further, the power control unit 340 may control the switching operation of the fourth switching device Q4 so that the second output voltage has a preset level irrespective of the change in level of the first output voltage. That is, by controlling the fourth switching device Q4, it is possible to control the head room voltage. Accordingly, if the level of the first output voltage is greater than a preset level (i.e., if the level of the first output voltage increases, resulting in increase in the head room voltage applied to the regulator), it is possible to control so that the fourth switching device Q4 alone is switched on. If the fourth switching device is switched on, only the third winding N3 operates, and as a result, the number of windings is reduced from when both the third winding N3 and the fourth winding N4 operate, and the head room voltage is decreased.

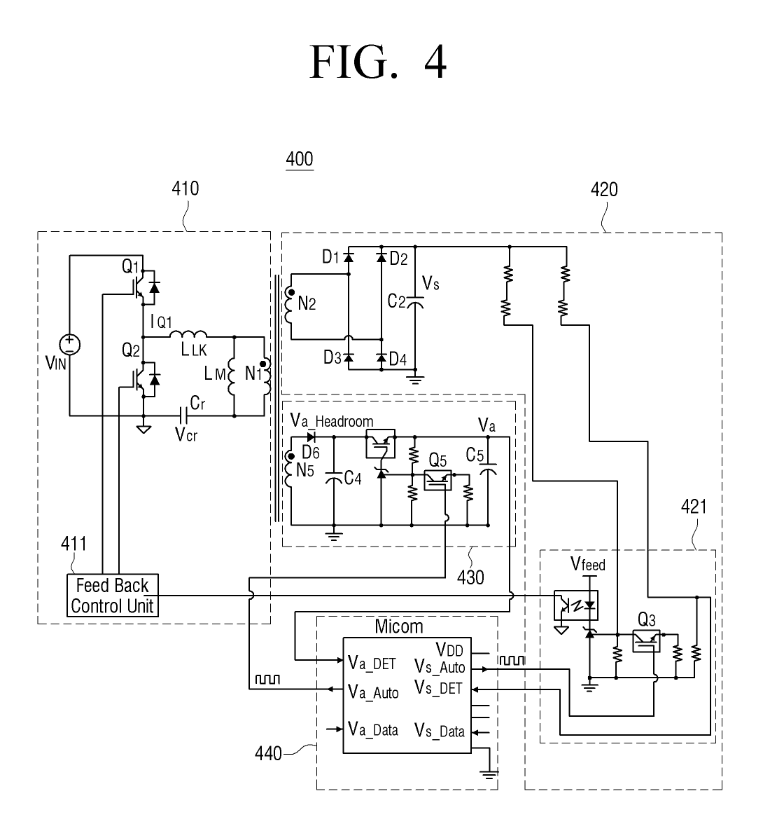

FIG. 4 is a circuit diagram of a multi output power supply apparatus according to another exemplary embodiment. Referring to FIG. 4, the multi output power supply apparatus 400 may include an input power unit 410, a feedback control unit 411, a primary output power unit 420, a feedback signal generating unit 421, a secondary output power unit 430, and a power control unit 440. Since the multi output power supply apparatus of FIG. 4 has a distinct constitution in terms of the secondary output power unit 430 and the power control unit 440, the other overlapping components will not be explained in detail for the sake of brevity.

The secondary output power unit 430 may include a fifth winding N5, a sixth diode D6 connected to the fifth winding N5, a fourth capacitor C4 and a fifth capacitor C5 connected in parallel with the fifth winding N5, a regulator, and a fifth switching device Q5 connected to the regulator.

The secondary output power unit 430 may operate in the manner explained below.

The fifth winding N5 may generate an induced current in response to the LLC resonance signal generated by the first winding N1 of the input power unit 410. The sixth diode D6 may rectify the voltage output from the fifth winding N5. The fourth capacitor C4 may level the voltage output from the sixth diode D6. The regulator may convert the voltage output from the fourth capacitor C4 so that the output voltage has a preset level. The fifth switching device Q5 may control the operation of the regulator.

The power control unit 440 may include a microcomputer MICOM and may operate in the manner explained below.

To be more specific, the power control unit 440 may control the input power unit 410 so that the LLC resonance signal is varied to cause the first output voltage to have a preset level. That is, the power control unit 440 may detect (Vs_DET) the first output voltage and control (Vs_Auto) the feedback signal generating unit 421 to generate a feedback signal to cause the first output voltage to have a preset level. Accordingly, the feedback signal generating unit 421 transfers the generated feedback signal to the feedback control unit 411 and the feedback control unit 411 may control the switching operation of the switching device of the power input unit 410 by changing a duty of a PWM signal so that the primary output power unit 420 outputs a predetermined level of voltage. That is, to increase the level of the first output voltage, a duty of the PWM signal applied at the gate end of the third switching device Q3 is increased, while to decrease the level of the first output voltage, a duty of the PWM signal applied at the gate end of the third switching device Q3 may be decreased.

Further, the power control unit 440 may control (Va_Auto) the switching operation of the fifth switching device Q5 of the secondary output unit 430 so that the second output voltage has a preset level irrespective of the change in level of the first output voltage. That is, the power control unit 440 may provide the fifth switching device Q5 with a PWM duty signal to cause the second output voltage to have a preset level. That is, to increase the level of the second output voltage, the duty of the PWM signal applied at the gate end of the fifth switching device Q5 is increased, while to decrease the level of the second of the second output voltage, the duty of the PWM signal applied at the gate end of the fifth switching device Q5 is decreased.

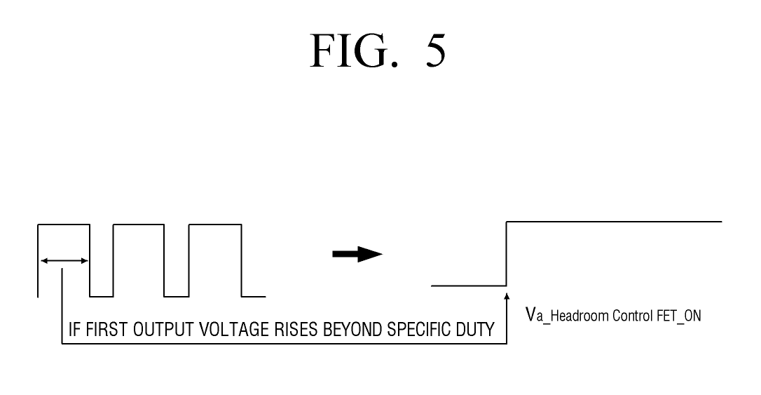

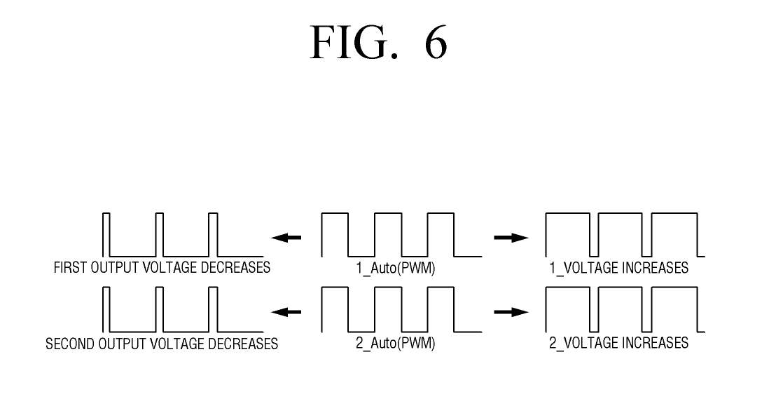

FIGS. 5 and 6 are views provided to explain a method for controlling a multi output power supply apparatus according to an exemplary embodiment.

Referring to FIG. 5, a method for controlling a head room voltage is shown. That is, the power control unit 340 may control the switching operation of the fourth switching device Q4 so that the second output voltage has a preset level irrespective of the change in level of the first output voltage. That is, it is possible to control the head room voltage by controlling the fourth switching device Q4. That is, if the level of the first output voltage is greater than a preset level (i.e., if the level of the first output voltage increases, resulting in increase in the head room voltage applied to the regulator), it is possible to control so that the fourth switching device Q4 alone is switched on. If the fourth switching device Q4 is switched on, only the third winding N3 operates, and as a result, the number of windings is reduced from when both the third winding N3 and the fourth winding N4 operate, and the head room voltage is decreased.

FIG. 6 illustrates a method for automatically controlling the first output voltage and the second output voltage according to an exemplary embodiment.

That is, to increase the level of the first output voltage, a duty of the PWM signal applied at the gate end of the third switching device Q3 is increased, while to decrease the level of the first output voltage, a duty of the PWM signal applied at the gate end of the third switching device Q3 may be decreased.

Further, to increase the level of the second output voltage, a duty of the PWM signal applied at the gate end of the fifth switching device Q5 is increased, while to decrease the level of the second output voltage, a duty of the PWM signal applied at the gate end of the fifth switching device Q5 may be decreased.

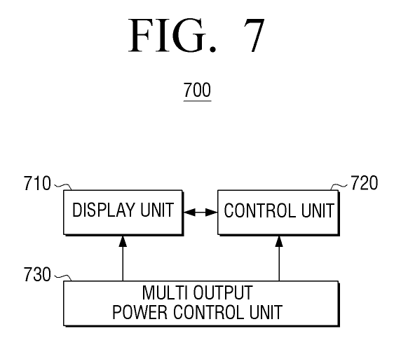

FIG. 7 is a block diagram of a display apparatus according to another exemplary embodiment. Referring to FIG. 7, a display apparatus 700 may include a display unit 710, a control unit 720, and a multi-output power supply unit 730.

The display unit 710 may carry out displaying images.

As used herein, the display unit 710 may be implemented as a liquid crystal display, a thin film transistor liquid crystal display, an organic light-emitting diode, a flexible display, or a three-dimensional (3D) display, etc.

The control unit 720 may control the function of the display unit 710.

The multi-output power supply unit 730 may carry out a function of supplying power to the display unit 710 and the control unit 720. As used herein, the multi output power supply unit 730 may be implemented as the multi output power supply apparatus explained above, but the detailed description thereof will be omitted for the sake of brevity.

As explained above, in various exemplary embodiments, it is possible to automatically adjust the output voltage in the multi output power supply apparatus. As a result, productivity increases.

Further, in various exemplary embodiments, it is possible to adjust the head room voltage in the multi output power supply apparatus. As a result, output efficiency is maximized.

The foregoing embodiments and advantages are merely exemplary and are not to be construed as limiting the present inventive concept. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. A multi output power supply apparatus, the multi output power supply apparatus comprising:
an input power unit which generates an LLC resonance signal by using DC power;
a primary output power unit which outputs a first output voltage based on a first voltage induced in response to the LLC resonance signal;
a secondary output power unit which outputs a second output voltage based on a second voltage induced in response to the LLC resonance signal; and
a power control unit which controls the input power unit to change the LLC resonance signal so that the first output voltage has a preset level, and controls the secondary output power unit so that the second output voltage has a preset level irrespective of a change in a level of the first output voltage.

2. The multi output power supply apparatus of claim 1, wherein the input power unit comprises a plurality of switching devices, a first winding, a first inductor, a second inductor and a first capacitor, and the LLC resonance signal is generated by the switching devices, the first winding, the first inductor, the second inductor, and the first capacitor.

3. The multi output power supply apparatus of claim 1, wherein the input power unit comprises:
a first switching device and a second switching device connected in series with the first switching device;
a first inductor connected commonly to the first switching device and the second switching device;
a first capacitor connected to the second switching device;
a second inductor connected to the first capacitor and the first inductor;
a first winding connected in parallel to the second inductor; and
a feedback control unit which controls a switching operation of the first switching device and the second switching device so that the LLC resonance signal is generated at a preset level.

4. The multi output power supply apparatus of claim 1, wherein the primary output power unit comprises:
a winding which generates an induced current in response to the LLC resonance signal;
a plurality of diodes which rectify a voltage output from the winding;
a capacitor which levels the rectified voltage to generate the first output voltage; and
a feedback signal generating unit which generates a feedback signal to cause the first output voltage to have the preset level.

5. The multi output power supply apparatus of claim 4, wherein the power control unit controls the feedback signal generating unit according to a level of the first output voltage, so that the feedback signal is generated, to cause the first output voltage to have the preset level.

6. The multi output power supply apparatus of claim 5, wherein the feedback signal generating unit comprises a switching device, and the power control unit outputs a PWM duty signal to the switching device to cause the first output voltage to have the preset level.

7. The multi output power supply apparatus of claim 1, wherein the secondary output power unit comprises:
a first winding and a second winding connected in series with the first winding, each of the first winding and second winding generating an induced current in response to the LLC resonance signal;
a switching device which switches to cause the second winding to operate selectively;
a diode which rectifies a voltage output from the first winding and the second winding, or a voltage output from only the first winding, according to a switching operation of the switching device;
a capacitor which levels the rectified voltage; and
a regulator which converts the leveled voltage to generate the second output voltage having the preset level,
wherein the power control unit controls the switching operation of the switching device so that the second output voltage has the preset level irrespective of a change in the level of the first output voltage.

8. The multi output power supply apparatus of claim 7, wherein the power control unit controls the switching device to switch on, if the level of the first output voltage is greater than a preset level.

9. The multi output power supply apparatus of claim 1, wherein the secondary output power unit comprises:
a winding which generates an induced current in response to the LLC resonance signal;
a diode which rectifies a voltage output from the winding;
a capacitor which levels a voltage output from the diode;
a regulator which converts a voltage output from the capacitor to a preset level; and
a switching device which controls a switching operation of the regulator,
wherein the power control unit controls a switching operation of the switching device so that the second output voltage has the preset level irrespective of a change in the level of the first output voltage.

10. The multi output power supply apparatus of claim 9, wherein the power control unit outputs a PWM duty signal to the switching device to cause the second output voltage to have the preset level.

11. A display apparatus comprising:
a display unit which displays an image;
a control unit which controls the display unit; and
a multi output power supply unit which supplies power to the display unit and the control unit,
wherein the multi output power supply unit comprises:
an input power unit which generates an LLC resonance signal using DC power,
a primary output power unit which outputs a first output voltage based on a first voltage induced in response to the LLC resonance signal,
a secondary output power unit which outputs a second output voltage based on a second voltage induced in response to the LLC resonance signal, and
a power control unit which controls the input power unit to change the LLC resonance signal so that the first output voltage has a preset level, and controls the secondary output power unit so that the second output voltage has a preset level irrespective of a change in a level of the first output voltage.

12. The display apparatus of claim 11, wherein the primary output power unit comprises:
a winding which generates an induced current in response to the LLC resonance signal;
a plurality of diodes which rectify a voltage output from the winding;
a capacitor which levels the rectified voltage to generate the first output voltage; and
a feedback signal generating unit which generates a feedback signal to cause the first output voltage to have the preset level.

13. The display apparatus of claim 12, wherein the feedback signal generating unit comprises a switching device, and the power control unit outputs a PWM duty signal to the switching device to cause the first output voltage to have the preset level.

14. The display apparatus of claim 11, wherein the secondary output power unit comprises:
a first winding and a second winding connected in series with the first winding, each of which generates an induced current in response to the LLC resonance signal;
a switching device which switches to cause the second winding to operate selectively;
a diode which rectifies a voltage output from the first winding and the second winding, or a voltage output from only the first winding, according to a switching operation of the switching device;
a capacitor which levels the rectified voltage; and
a regulator which converts the leveled voltage to output the second output voltage having the preset level,
wherein the power control unit controls the switching operation of the switching device so that the second output voltage has the preset level irrespective of the change in the level of the first output voltage.

15. The display apparatus of claim 14, wherein, if the level of the first output voltage is greater than a preset level, the power control unit controls the switching device to switch on.

16. The display apparatus of claim 11, wherein the secondary output power unit comprises:
a winding which generates an induced current in response to the LLC resonance signal;
a diode which rectifies a voltage output from the winding;
a capacitor which levels a voltage output from the diode;
a regulator which converts a voltage output from the capacitor to output the second output voltage having the preset level; and
a switching device which controls a switching operation of the regulator,
wherein the power control unit controls a switching operation of the switching device so that the second output voltage has the preset level irrespective of the change in the level of the first output voltage.

17. The display apparatus of claim 16, wherein the power control unit outputs a PWM duty signal to the switching device to cause the second output voltage to have the preset level.

18. The multi output power supply apparatus of claim 3, wherein the primary output power unit comprises:
a second winding which generates an induced current in response to the LLC resonance signal;
a plurality of diodes which rectify a voltage output from the second winding;
a second capacitor which levels the rectified voltage to generate the first output voltage; and
a feedback signal generating unit which generates a feedback signal to cause the first output voltage to have the preset level.

19. The multi output power supply apparatus of claim 18, wherein the secondary output power unit comprises:
a third winding and a fourth winding connected in series with the third winding, each of the third winding and fourth winding generating an induced current in response to the LLC resonance signal;
a third switching device which switches to cause the fourth winding to operate selectively;
a headroom diode which rectifies a voltage output from the third winding and the fourth winding, or a voltage output from only the third winding, according to a switching operation of the third switching device;
a third capacitor which levels the rectified voltage; and
a regulator which converts the leveled voltage to generate the second output voltage having the preset level,
wherein the power control unit controls the switching operation of the third switching device so that the second output voltage has the preset level irrespective of a change in the level of the first output voltage.

20. The multi output power supply apparatus of claim 19, wherein if the level of the first output voltage is greater than a preset level, the power control unit controls the third switching device to switch on.

21. A multi output power supply for use in a display apparatus, the multi output power supply comprising:
an input power unit which generates a resonance signal using DC power, the resonance signal being generated in accordance with a feedback signal;
a primary power unit which outputs a first voltage in response to the resonance signal, and generates the feedback signal;
a secondary power unit which comprises a regulator and a switching device connected to an input of the regulator, the regulator outputting a second voltage in response to the resonance signal; and
a power controller which controls the feedback signal in order to maintain the first voltage at a preset level, and controls the switching device to change the input of the regulator in accordance with a level of the first voltage.

22. The multi output power supply of claim 21, wherein if the level of the first voltage is greater than a threshold level, the power controller controls the switching device to decrease an input level of the regulator.
